(19) United States
(12) Patent Application Publication
(10) Pub. No.: US 2011/0201330 A1
(43) Pub. Date: Aug. 18, 2011

(54) WIRELESS COMMUNICATION SYSTEM AND ACQUISITION METHOD FOR MOBILE LOCATION INFORMATION IN A WIRELESS COMMUNICATION SYSTEM

(76) Inventors: Shigeyasu Kubo, Chigasaki (JP); Akihiko Yoshida, Yokohama (JP)

(21) Appl. No.: 13/012,041

(22) Filed: Jan. 24, 2011

(30) Foreign Application Priority Data
Feb. 15, 2010 (JP) 2010-029658

(51) Int. Cl. H04W 24/00; H04W 68/00; H04W 64/00

(52) U.S. Cl. 455/432.1; 455/458; 455/456.1

(57) ABSTRACT

A maintenance and administration device of a wireless communication system having for an object to enable the acquisition of accurate location information, even with respect to mobile handsets in the Idle state, sets a mobile handset subscriber identifier and a paging flag to be valid and transmits a visited cell information acquisition request with respect to a call processing control device. In the case where the paging flag is set to be valid, the call processing control device transmits a paging message to the mobile handset, with the mobile handset in the Idle state, and makes it return a reply message. The call processing control device reports, to the maintenance and administration device, the cell having progressively transmitted the paging message reply message as mobile handset visited cell information.

### INCORPORATION BY REFERENCE

The present application claims priority from Japanese application JP2010-029658 filed on Feb. 15, 2010, the content of which is hereby incorporated by reference into this application.

### BACKGROUND OF THE INVENTION

1. Field of the Invention

The present invention pertains to a wireless communication system and pertains in particular to technology for acquiring location information in a wireless communication system.

2. Description of the Related Art

In a wireless communication system, there is a mobile tracking function for tracking the location of mobile handsets. If the mobile tracking function is used, it is possible, by acquiring location information about the handset under consideration and verifying the presence information, to carry out tracking of the handset. This function is e.g. used for tracking the mobile handset possessed by a malicious user or a crime-related user.

In existing wireless communication systems, it is a call processing control device that grasps the mobile handset location information. The call processing control device acquires mobile handset location information in units of cells and manages the same per area. A paging area is composed of a plurality of base stations or cells and is an area for reporting that an incoming call has come with respect to mobile handsets in an idle state. A change in the location information is carried out so that, if the mobile handset moves and the paging area changes, the mobile handset transmits a location registration request with respect to the call processing control device and the call processing control device having received this changes the location information and, if the location registration has reached completion, transmits a registration completion signal to the mobile handset.

An Operation Administration and Maintenance (OAM) device carrying out the maintenance and operations administration of the wireless communication system is provided with the aforementioned mobile handset tracking function. If the maintenance staff starts mobile handset tracking processing for tracking the handset of a malicious user or a crime-related user, a visited cell information acquisition request is transmitted from the OAM device to the call processing control device. However, the ability to acquire information about the visited cell is limited to cases where there is an “Active” state having issued a call. Since a mobile handset in the Active state is carrying out data communication or voice communication via a base station, there results information that the cell that is attached to the base station currently carrying out communication is the visited cell. The call processing control device, in case the mobile handset is in an Active state, reports, to the OAM device, the cell attached to the base station currently carrying out communication as visited cell information.

Moreover, in the case where the mobile handset under consideration has not issued a call and is in the Idle state in which communication is possible and it is on standby, the mobile handset is present in the cell in a state in which communication with the base station is cut in order to restrain battery consumption. Since the mobile handset is not carrying out communication with the base station, the call processing control device is not able to recognize in which cell, out of a plurality of cells inside the paging area, it is present. Accordingly, the call processing control device, in case the mobile handset is in the Idle state, reports, with respect to a visited cell information acquisition request from the OAM device, the cell, or all the cells attached to the paging area to which the mobile handset was last connected, to the OAM device. Since the paging area is composed of a plurality of base stations or cells, the accuracy is poor as mobile handset location information. That is, it is uncertain in which of the plurality of cells the mobile handset locates. Since location registration does not occur inside the paging area, it is possible for the mobile handset to move between cells inside the paging area in a state in which communication with the base station is cut. As a result, information about the cell in which the handset was last connected also has poor accuracy as information about the currently visited cell. That is, it is also uncertain whether the handset in question locates within the last-connected-cell or not.

In this way, even if the maintenance staff requests tracking of a mobile handset using a mobile handset tracking function, it is not possible for the OAM device to acquire accurate information about the visited cell in case the mobile handset is in the Idle state, since the call processing control device can only recognize the location of the mobile handset in the paging area or the last connected cell.

As a method of more accurately getting a grasp of location information about mobile handsets which are in the Idle state and the Active state, there is the method using GPS communication. By activating, with remote control from the OAM device, the GPS of the mobile handsets under consideration, it can also be thought that the mobile handset tracking function is implemented. Since in this case, there may, at the time of GPS activation, occur things like an activation sound or vibrations due to a vibrator being generated by the mobile handset, or there being a display on the screen, there is also the possibility that this is noticed, and that the power ends up being turned off, by the user of the mobile handset. In addition, there is also the problem that GPS communication ends up consuming the power of the mobile handset in no small quantities in order to communicate with geostationary satellites. It can be considered that it occurs often that the mobile handset tracking function is carried out continuously, so as a result of the electric energy of the mobile handset being consumed by frequent GPS communication, the battery capacity of the mobile handset drops suddenly and the power supply ends up getting turned off automatically, and from then onward, it can be thought that the opportunity to track the mobile handset under consideration ends up getting lost. In the case of tracking the mobile handset of a malicious user or a crime-related user, it is mandatory to carry out a method that is not noticed by the user and which has low electric energy consumption.

In JP-A-HEI11-266476, the counterpart US Patent of which is U.S. Pat. No. 6,778,836, there is set forth mobile handset tracking technology for tracking continuously the position of a mobile handset under consideration, in case a request for location information pertaining to a mobile handset in the Active state is performed. In JP-A-HEI11-266476, no indication is given regarding a method of tracking the position of a mobile handset in the Idle state.

### SUMMARY OF THE INVENTION

The present invention is one made to resolve the aforementioned problems and has for an object to enable the acquisition of accurate location information, even for a mobile handset in the Idle state.

In order for the maintenance staff to track which cell currently has the concerned mobile handset under its control, the OAM device sets the subscriber identifier and the paging flag of the mobile handset to be valid and transmits an acquisition request for visited cell information to the call processing control device, In case the mobile handset having received an enquiry about mobile handset visited cell information from the OAM device is in the Idle state, and the paging flag is set to be valid, the call processing control device transmits a paging message to the concerned mobile handset, and the mobile handset is made to return a paging message reply message. When the mobile handset returns the paging message reply message, it makes a transition to the Active state and since the result is that communication is carried out with the call processing control device via the base station, the call processing control device is able to find out information about the visited cell of the mobile handset. The call processing control device takes the cell that has gradually transmitted the paging message reply message as information about the visited cell of the mobile handset and reports the visited cell information to the OAM device.

According to the present invention, it becomes possible for the maintenance staff to immediately get a grasp of accurate location information, even for a mobile handset in the Idle state.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing the configuration of a wireless communication system applying the present invention.

FIG. 2 is a block diagram showing the configuration of a mobile handset associated with an embodiment of the present invention.

FIG. 3 is a block diagram showing the configuration of a base station associated with an embodiment of the present invention.

FIG. 4 is a block diagram showing the configuration of a call processing control device associated with an embodiment of the present invention.

FIG. 5 is a block diagram showing the configuration of an OAM device associated with an embodiment of the present invention.

FIG. 6 is a sequence diagram explaining the processing contents of mobile handset tracking processing associated with an embodiment of the present invention.

FIGS. 7A and 7B are diagrams describing a paging area information database and a subscriber information database of a mobile handset.

FIGS. 8A to 8C are diagrams describing a base station database of a base station.

FIGS. 9A to 9C are diagrams describing a paging area information database, a subscriber information database, and a base station information database of a call processing control device.

FIGS. 10A to 10C are diagrams showing a mobile handset tracking processing condition database, a mobile handset location information database, a wireless communication system class database of an OAM device.

FIGS. 11A and 11B are diagrams describing a subscriber information database and a paging area information database of a call processing control device after starting wireless communication service.

FIG. 12 is a diagram describing a paging area information database of a mobile handset after receiving wireless communication service start permission from a call processing control device.

FIGS. 13A and 13B are diagrams describing a mobile handset tracking condition database and a wireless communication system class database of an OAM device.

FIG. 14 is a diagram showing a mobile handset location information database of an OAM device.

FIGS. 15A and 15B are diagrams showing a wireless communication system class database of an OAM device associated with an embodiment of the present invention and a mobile handset tracking process sequence.

FIGS. 16A and 16B are diagrams showing a wireless communication system class database of an OAM device associated with an embodiment of the present invention and a mobile handset tracking process sequence.

### DETAILED DESCRIPTION OF THE INVENTION

Hereinafter, embodiments of the present invention will be described in detail with reference to the drawings.

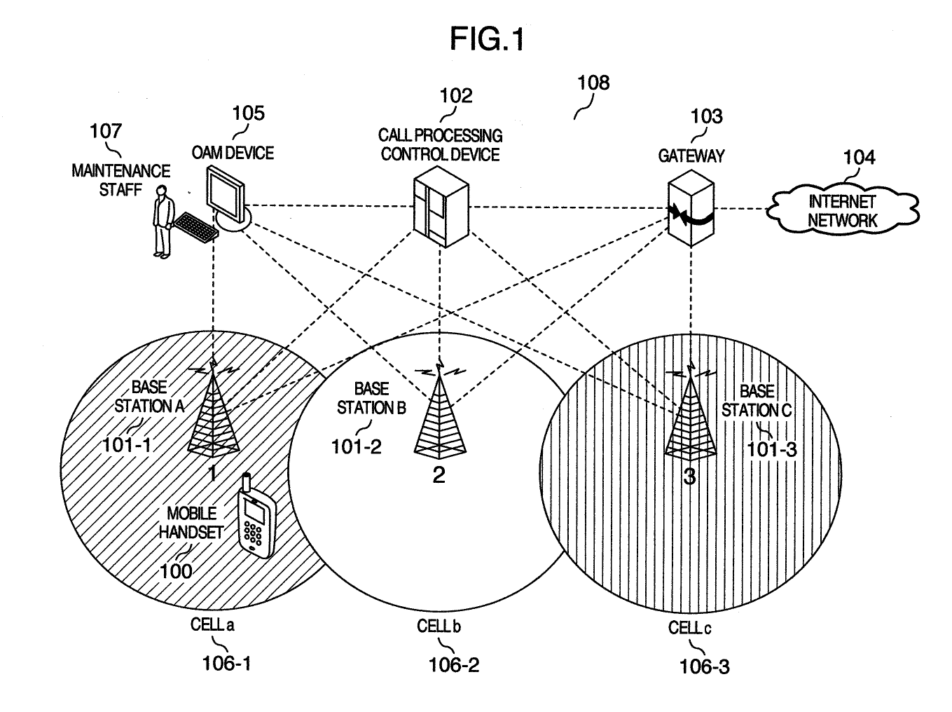

FIG. 1 is a diagram showing the configuration of a wireless communication system applying the present invention.

In FIG. 1, only one mobile handset 100 is illustrated, but even if there is a plurality of mobile handsets 100, it is possible to make an implementation by carrying out the same processing as that described hereinafter for the plurality of mobile handsets.

In FIG. 1, a wireless communication system 108 is provided with a mobile handset 100, a base station A 101-1, a base station B 101-2, a base station C 101-3, a call processing control device 102, a gateway 103, an Internet network 104, and an OAM device 105.

Base station A 101-1, base station B 101-2, and base station C 101-3 are respectively provided with a cell a 106-1, a cell b 106-2, and a cell c 106-3. Mobile handset 100 and base stations 101 carry out communication by wireless means. Base stations 101, call processing control device 102, gateway 103, and OAM device 105 are connected by wire in a mesh form. Gateway 103 is connected with Internet network 104. In the case of e.g. carrying out data communication, mobile handset 100 carries out data transmission and reception to and from servers located in Internet network 104, via base stations 101 and gateway 103.

Using OAM device 105, maintenance staff 107 starts mobile handset tracking processing for tracking which cell currently has mobile handset 100 under its control. OAM device 105 makes an enquiry to call processing control device 102 about mobile handset 100 visited cell information.

In the case where call processing control device 102 judges that the mobile handset 100 having received a visited cell information enquiry from OAM device 105 is not present in its own database, reports that mobile handset 100 is not present to OAM device 105.

Moreover, in the case where call processing control device 102 recognizes that the mobile handset 100 having received the visited cell information enquiry from OAM device 105 is in communication with a base station 101 and is present in its own database, reports information about cell 106 in which mobile handset 100 is currently present to OAM device 105.

Call processing control device 102 recognized that the mobile handset 100 having received a visited cell information enquiry from OAM device 105 is present in its own database, but in the case where it has not been able to get a grasp of visited cell information because mobile handset 100 is in the Idle state, the present embodiment is applied.

In the present embodiment, there is provided a paging flag in the mobile handset tracking processing. This paging flag is a flag that sets whether or not paging is carried out in the mobile handset tracking processing. Maintenance staff 107, at the time of mobile handset tracking processing, sets the paging flag together with the subscriber identifier of the mobile handset 100 subject to tracking.

In the case of receiving, in a state with the paging flag set to be valid, an enquiry for visited cell information about mobile handset 100 from OAM device 105, and in the case where mobile handset 100 is in the Idle state, call processing control device 102 transmits a paging message to mobile handset 100 via a base station 101. Mobile handset 100, having received the paging message, replies to call processing control device 102 via base station 101. When mobile handset 100 transmits the reply message for the paging message to call processing control device 102, base station 101 adds information about the cell 106 in which mobile handset 100 has progressively transmitted the paging message reply message and transfers the same to call processing control device 102. Call processing control device 102 reports the information about cell 106 received from base station 101 as visited cell information of mobile handset 100 under consideration to OAM device 105. In the case of transmission of a paging message based on the enquiry for visited cell information from the OAM device, the call processing control device terminates the processing without carrying out other processing such as guaranteeing resources even if receiving a reply message from the mobile handset under consideration.

In the case of setting the paging flag to be invalid, call processing control device 102 does not carry out paging even if mobile handset 100 is in the Idle state. In the case where call processing control device 102 receives a visited cell information acquisition request from OAM device 105 in a state where the paging flag is set to be invalid, it reports, similarly to the prior art, all information about the plurality of cells attached to the paging area or the information about the cell with which mobile handset 100 was last connected, to the OAM device.

Maintenance staff 107 can freely change, in the mobile handset tracking processing, whether call processing control device 102 transmits paging or not with respect to mobile handsets in the Idle state.

Next, an explanation will be given regarding the configuration of the mobile handset.

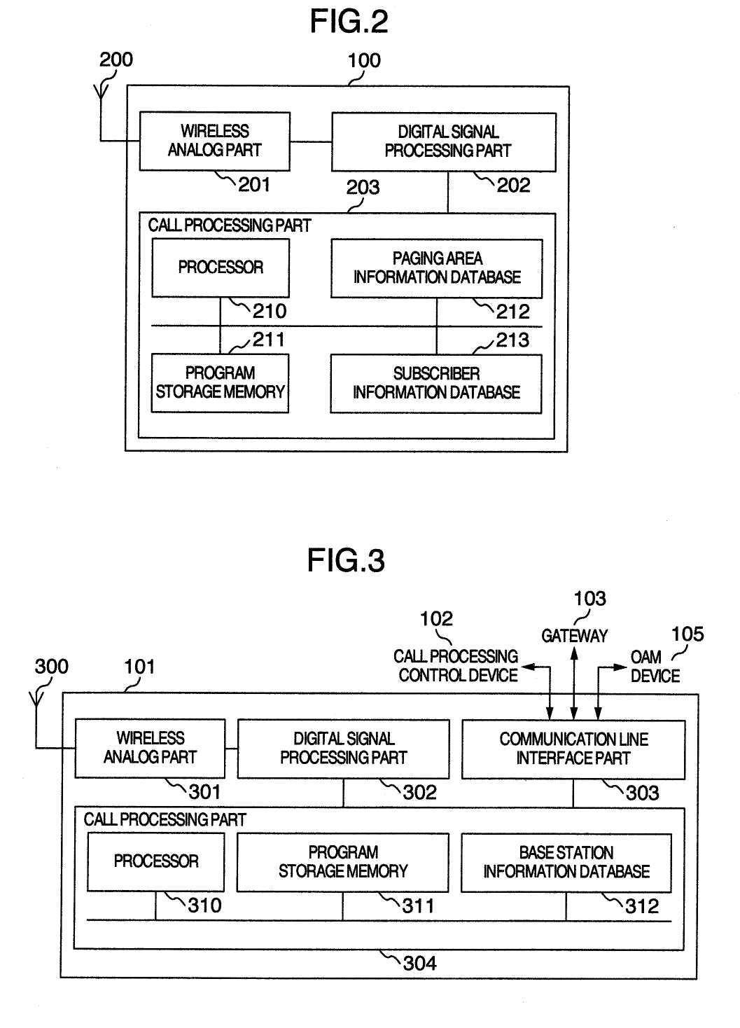

FIG. 2 is a block diagram showing the configuration of a mobile handset associated with an embodiment of the present invention.

Mobile handset 100 is provided with one or more transmission and reception antennas 200, a wireless analog part 201 connected with each antenna 200, a digital signal processing part 202 connected with wireless analog part(s) 201, and a call processing part 203 connected with digital signal processing part 202.

Here, wireless analog part 201 converts an analog signal from base station 101 that is received via antenna 200 into a digital signal and outputs the same to digital signal processing part 202. Also, wireless analog part 201 converts a digital signal received from digital signal processing part 202 into an analog signal and transmits the same to base station 101 via antenna 200. Digital signal processing part 202 carries out demodulation of the signal from wireless analog part 201 and modulation of the signal to base station 101. Call processing part 203 is provided with a processor (control part) 210, a memory 211 storing programs and the like that are executed by processor 210, a paging area information database 212 storing information about cells that are attached to the paging area, and a subscriber information database 213 that stores information about the mobile handset 100 subscriber. It is acceptable for paging area information database 212 and subscriber information database 213 not to be stored in separate memories but inside one memory.

Mobile handset 100 has a function of transmitting a wireless communication service start request via base station 101 to call processing control device 102, a function of setting information about cells attached to the paging area at the time of receiving permission for the start of wireless communication service from call processing control device 102 via base station 101, and a function of replying to a paging message when the paging message is received from call processing control device 102 via base station 101.

Next, an explanation will be given regarding the configuration of a base station.

FIG. 3 is a block diagram showing the configuration of a base station associated with an embodiment of the present invention.

Base station 101 is provided with one or more transmission and reception antennas 300, wireless analog parts 301 which are respectively connected with one of antennas 300, a digital signal processing part 302 connected with these wireless analog parts 301, a call processing part 304 connected with digital signal processing part 302, and a communication line interface part 303 connected with call processing part 304. Communication line interface part 303 is connected with call processing control device 102, gateway 103, and OAM device 105.

Here, wireless analog part 301 converts an analog signal from mobile handset 100 received via antenna 300 into a digital signal and outputs the same to digital signal processing part 302. Also, wireless analog part 301 converts the digital signal received from digital signal processing part 302 into an analog signal and transmits the same to mobile handset 100 via antenna 300. Digital signal processing part 302 carries out demodulation of the signal from wireless analog part 301 and modulation of the signal to mobile handset 100 and call processing part 304 is provided with a process (control part) 310, a memory 311 storing programs and the like that are executed by processor 310, and a base station information database 312 storing cell identifiers of base station 101.

Base station 101 is provided with a function to transmit a wireless communication service start request received from the mobile handset to call processing control device 102, a function to transmit a wireless communication service start permission received from call processing control device 102 to mobile handset 100, a function to transmit a paging message transmitted from call processing control device 102 to mobile handset 100, a function of adding a paging message reply message transmitted from mobile handset 100 to the mobile handset visited cell information and transmitting the same to call processing control device 102, and the like.

Next, an explanation will be given regarding the call processing control device.

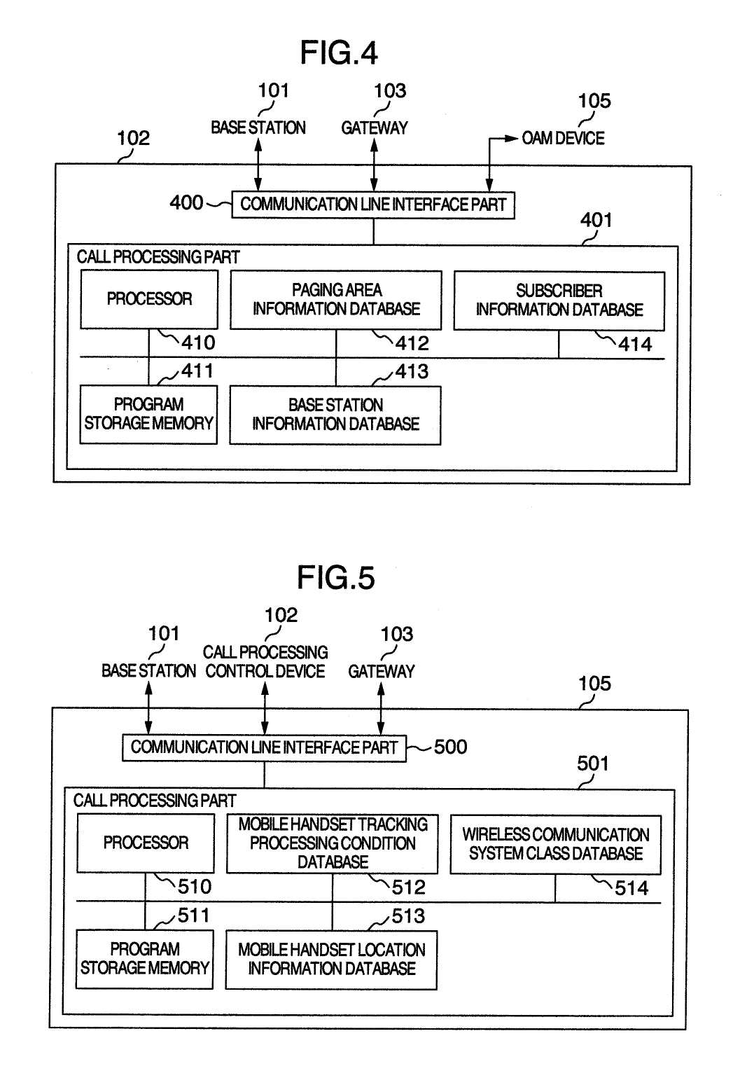

FIG. 4 is a block diagram showing the configuration of a call processing control device associated with an embodiment of the present invention.

Call processing control device 102 is provided with a communication line interface part 400 connected with base station 101, gateway 103, and OAM device 105, and a call processing part 401 connected with communication line interface part 400.

Here, call processing part 401 is provided with a processor (control part) 410, a memory 411 storing programs and the like that are executed by processor 410, a paging area information database 412 storing information about the plurality of cells 106 attached to the paging area, a base station information database 413 storing the cell identifiers of base station 101, and a subscriber information database 414 storing mobile handset 100 subscriber information. It is acceptable for paging area information database 412, base station information database 413, and subscriber information database 414 not to be stored in separate memories but inside one memory.

Call processing control device 102 has a function of carrying out setting processing for the start of wireless communication service after reception of a wireless communication service start request transmitted by mobile handset 100 via base station 101, a function of reporting to mobile handset 100 via base station 101 the fact that settings for wireless communication service start have been completed, a function of transmitting a paging message via base station 101 to a mobile handset 100 in an Idle state when a paging flag is set to be valid for a visited cell information acquisition request when OAM device 105 has started mobile handset tracking processing and received a visited cell information acquisition request and when mobile handset 100 is in the Idle state, a function of reporting, to the OAM device, visited cell information included in a paging message reply message after reception of a paging message reply message from mobile handset 100 via base station 101, and the like.

Next, an explanation will be given regarding the OAM device.

FIG. 5 is a block diagram showing the configuration of an OAM device associated with an embodiment of the present invention.

OAM device 105 is provided with a communication line interface part 500, connected with base station 101, call processing control device 102, and gateway 103, and a call processing part 501 connected with communication line interface 500.

Here, call processing part 501 is provided with a processor (control part) 510, a memory 511 storing programs and the like that are executed by processor 510, a mobile handset tracking processing condition database 512 storing mobile handset tracking processing conditions, a mobile handset location information database 513 storing visited cell information about the mobile handset, and a wireless communication system class database 514 for storing which wireless communication system 108 that maintenance staff 107 has taken to be the object of mobile handset tracking processing. It is acceptable for mobile handset tracking processing condition database 512, mobile handset location information database 513, and wireless communication system class database 514 not to be stored in separate memories but inside one memory.

OAM device 105 is provided with a function of starting mobile handset tracking processing on the basis of mobile handset tracking processing conditions input by the maintenance staff, a function of displaying the result of the mobile handset tracking processing and the acquired visited cell information of mobile handset 100 to maintenance staff 107, a function of starting mobile handset tracking processing in a designated wireless communication system 108 in the case where maintenance staff 107 has designated a wireless communication system 108 that it wants to become an object of mobile handset tracking processing.

Next, there will be given an explanation of the processing sequence of the mobile handset tracking processing associated with an embodiment of the present invention.

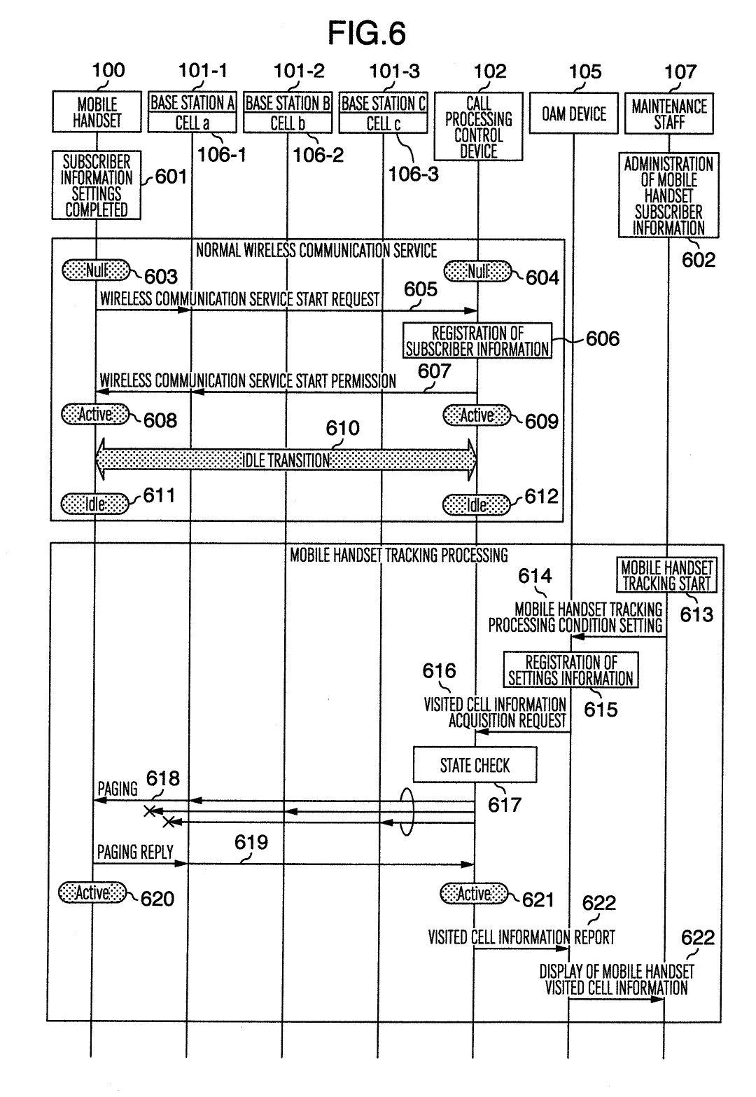

FIG. 6 is a sequence diagram explaining the processing contents of mobile handset tracking processing associated with an embodiment of the present invention.

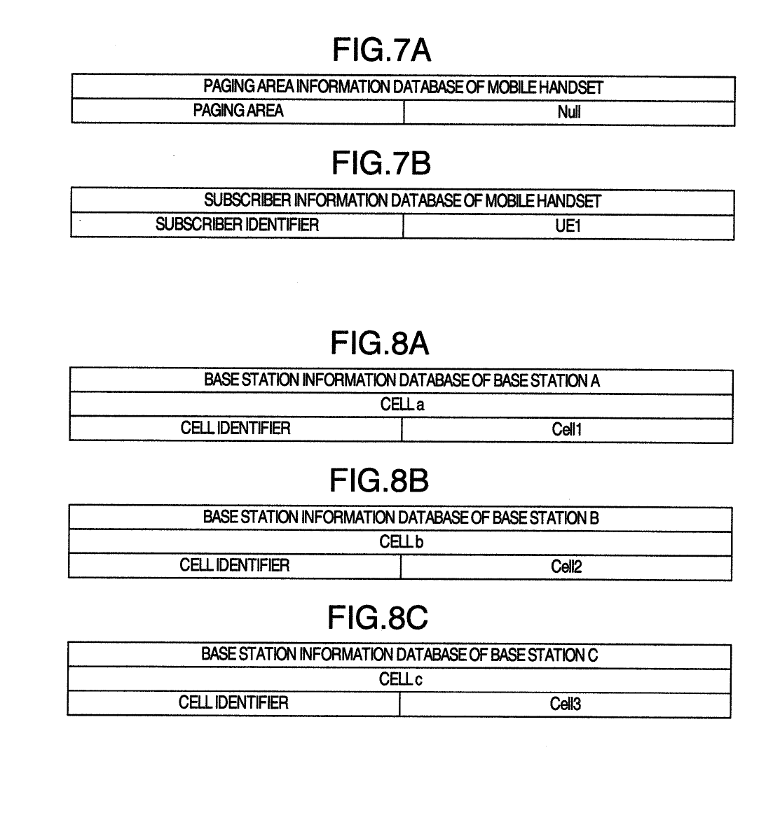

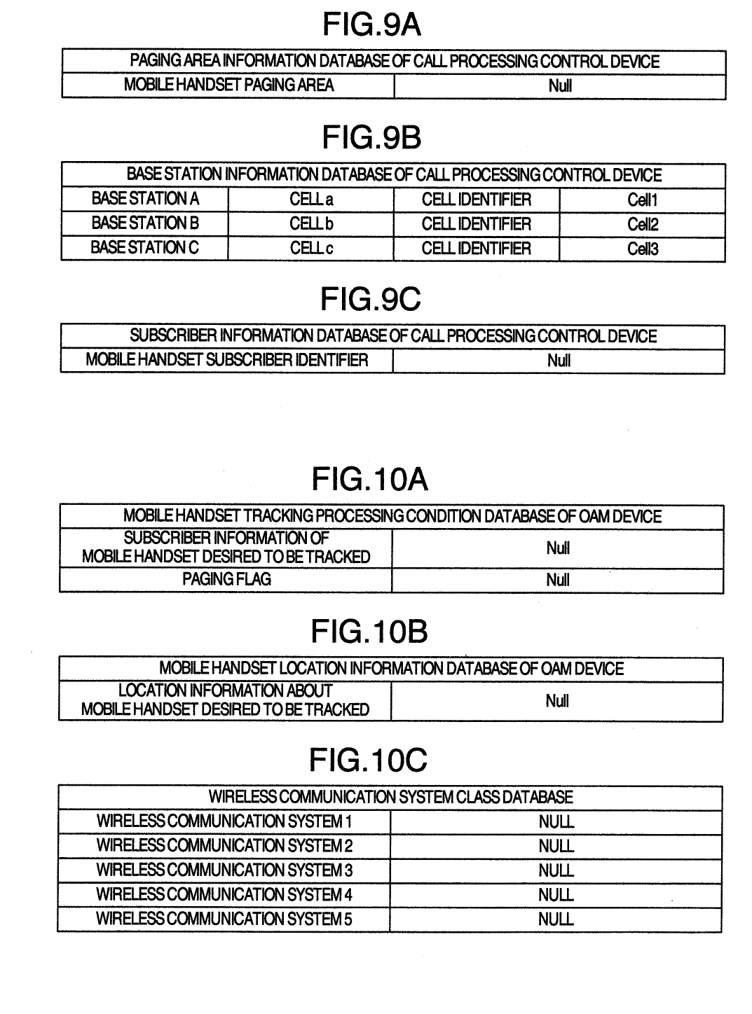

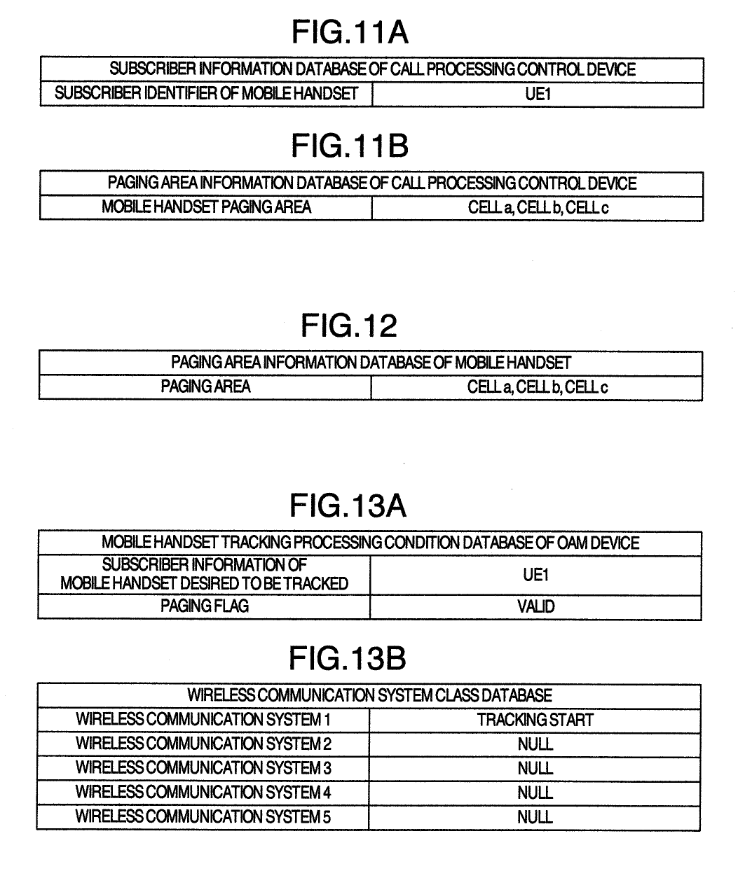

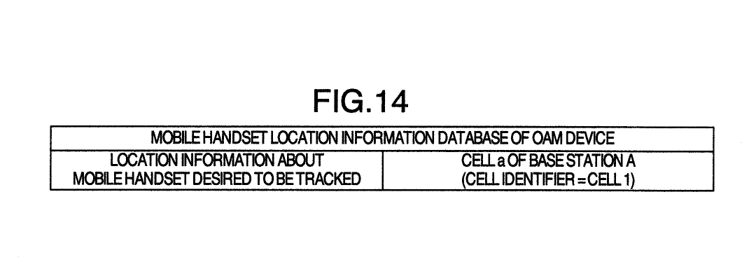

In FIG. 6, there is shown processing in the case where maintenance staff 107 acquires visited cell information about mobile handsets 100 in an Idle state. The explanation of the sequence diagram of FIG. 6 will be carried out together with the information elements of the databases of the respective devices of FIG. 7, FIG. 8, FIG. 9, FIG. 10, FIG. 11, FIG. 12, FIG. 13, and FIG. 14. Out of these, FIG. 7 to FIG. 10, inclusive, are diagrams showing the initial information elements of each of the devices used in explaining the present embodiment.

FIGS. 7A and 7B are diagrams describing a paging area information database and a subscriber information database of a mobile handset.

In paging area information database 212 of mobile handset 100, shown in FIG. 7A, since the situation is one before the start of wireless communication service, “Null” is set as paging area information. In subscriber information database 213 of mobile handset 100, shown in FIG. 7B, there is here set UE (User Equipment) 1 as an example of information about the subscriber of mobile handset 100. The subscriber information about mobile handset 100 is identifiers that are pre-allocated depending on the operator that is offering the wireless communication service.

FIGS. 8A to 8C are diagrams describing a base station database of a base station.

In base station information database 312 of base station A 101-1 in FIG. 8A, there is set “Cell 1” as the cell identifier. In base station information database 312 of base station B 101-2 in FIG. 8B, there is set “Cell 2” as the cell identifier. In base station information database 312 of base station C 101-3 in FIG. 8C, there is set “Cell 3” as the cell identifier. The cell identifiers of base station 101 are identifiers that are pre-allocated depending on the operator that is offering the wireless communication service.

FIGS. 9A to 9C are diagrams describing a paging area information database, a subscriber information database, and a base station information database of a call processing control device.

In paging area information database 412 of call processing control device 102 in FIG. 9A, since the situation is one before the start of wireless communication service, “Null” is set as paging area information. In base station information database 413 of the call processing control device in FIG. 9B, as identifiers for cell a 106-1 administered by base station A 101-1, cell b 106-2 administered by base station B 101-2, and cell c 106-3 administered by base station C 101-3, there are respectively set “Cell 1”, “Cell 2”, and “Cell 3”. These cell identifiers are identifiers that are pre-allocated by the operators providing the wireless communication service. In subscriber information database 414 of call processing control device 102 in FIG. 9C, “Null” is set. The subscriber information items of mobile handset 100 are information elements included in the wireless communication service start request transmitted from mobile handset 100.

FIGS. 10A to 10C are diagrams describing a mobile handset tracking processing condition database, a mobile handset location information database, a wireless communication system class database of an OAM device.

In mobile handset tracking processing condition database 512 of OAM device 105 in FIG. 10A, “Null” is set for the subscriber information item of the mobile handset 100 desired to be tracked and the paging flag. In mobile handset location information database 513 of OAM device 105 in FIG. 10B, “Null” is set as the location information of the mobile handset 100 desired to be tracked. The information items of mobile handset tracking processing condition database 512 and mobile handset location information database 513 are information elements that are set at the time when maintenance staff 107 starts mobile handset tracking processing with respect to mobile handset 100. In wireless communication system class database 514 in FIG. 10C, “Null” is set.

In FIG. 6, as for mobile handset 100, “UE1” is already set in subscriber information database 213 of mobile handset 100 and the wireless communication service is utilized using the “UE1” subscriber information (Step 601). Moreover, maintenance staff 107 administers the subscriber information of mobile handset 100 carrying out wireless communication service as “UE1” (Step 602). Since mobile handset 100 does not carry out the settings necessary for wireless communication service prior to carrying out the wireless communication service, it is in the “Null” state indicating the situation before starting the wireless communication service (Step 603). Since call processing control device 102 has not received a wireless communication service start request from mobile handset 100, the state with respect to mobile handset 100 is set to “Null” (Step 604).

Mobile handset 100 transmits a wireless communication service start request including subscriber information via base station 101 to call processing control device 102 (Step 605). Call processing control device 102 receives the wireless communication service start request from mobile handset 100 and sets subscriber information included in the wireless communication service start request in its own subscriber information database 414 (Step 606). Call processing control device 102 determines an area (paging area) for transmitting paging messages to mobile handset 100.

FIGS. 11A and 11B are diagrams describing a subscriber information database and a paging area information database of a call processing control device after starting wireless communication service.

FIG. 11A is a diagram showing subscriber information database 414 after reception of the wireless communication service start request. Call processing control device 102 sets subscriber information item “UE1” included in the wireless communication service start request in subscriber information database 414. FIG. 11B is a diagram showing paging area information database 412 of the mobile handset after reception of the wireless communication service start request. Call processing control device 102 allocates a paging area to mobile handset 100 after reception of the wireless communication service start request. Call processing control device 102 allocates, as the paging area, cell a 106-1 administered by base station A 101-1, cell b 106-2 administered by base station B 101-2, and cell c 106-3 administered by base station C 101-3, and sets “Cell 1”, “Cell 2”, and “Cell 3” in paging area information database 412. Call processing control device 102 administers the subscriber information of mobile handset 100 as “UE1” and the paging area of mobile handset 100 as “Cell 1”, “Cell 2”, and “Cell 3”. Also, call processing control device 102 transmits a wireless communication service start permission including the paging area to mobile handset 100 (Step 607).

FIG. 12 is a diagram describing a paging area information database of a mobile handset after receiving wireless communication service start permission from a call processing control device.

In FIG. 12, there is shown paging area information database 212 of mobile handset 100 after receiving wireless communication service start permission from call processing control device 102.

In the wireless communication service start permission, “Cell 1”, “Cell 2”, and “Cell 3” are set as paging area information. Mobile handset 100 sets “Cell 1”, “Cell 2”, and “Cell 3” in paging area information database 212 of mobile handset 100. Mobile handset 100, having received wireless communication service start permission, becomes enabled to carry out wireless communication and makes a transition to the Active state which is a communication state (Step 608).

Since call processing control device 102 has given wireless communication service start permission to mobile handset 100, the state with respect to mobile handset 100 makes a transition to the Active state (Step 609). Thereafter, in case mobile handset 100 has not communicated for a fixed time interval, mobile handset 100 and call processing control device 102 automatically make a transition to the Idle state (Step 610). Mobile handset 100 and call processing control device 102, after the Idle transition, change from the Active state to the Idle state (Step 611 and Step 612).

In case a need to track mobile handset 100 has occurred, maintenance staff 107 starts mobile handset tracking processing for tracking which cell currently has mobile handset 100 under its control, using OAM device 105 (Step 613). The maintenance staff carries out mobile handset tracking processing using the subscriber information of mobile handset 100.

Maintenance staff 107 sets “UE1” as the subscriber information of mobile handset 100. Also, in the present embodiment, a paging flag is provided as a mobile handset tracking processing parameter. The paging flag is a parameter for setting, in the mobile handset tracking processing, whether or not paging is transmitted from call processing control device 102 in the case where the mobile handset 100 subject to tracking is in the Idle state. Normally, in case there is an incoming call in the mobile handset, the paging message is transmitted from the call processing control device with respect to the cells inside the paging area. In the present embodiment, focusing on this paging message, the information of the same paging flag is included in the visited cell information acquisition request transmitted from the OAM device to the call processing control device and transmitted, in case the maintenance staff has set the paging flag to be valid as the parameter of the mobile handset tracking processing. If the call processing control device receives a visited cell information acquisition request with a valid paging flag, a paging message with respect to the cells of the paging area of the mobile handset under consideration is transmitted, even if there is no incoming call to the mobile handset. In normal paging, if there is a paging reply from the mobile handset under consideration, call connection processing is carried out, but in the case of paging on the basis of a visited cell information acquisition request from the OAM device of the present embodiment, even if there is a paging reply from the mobile handset under consideration, there is not carried out call connection processing such as guaranteeing resources. If it receives a paging reply from the mobile handset under consideration, the call processing control device takes the cell that transmitted the same reply message to be visited cell information about the mobile handset under consideration and carries out processing of reporting to the OAM device without carrying out the call connection processing carried out with normal paging. In this way, in the present embodiment, paging is utilized to have the mobile handset under consideration make a transition to the Active state and get a grasp of visited cell information.

Returning to FIG. 6, in the setting of conditions for the mobile handset tracking processing (Step 614), the maintenance staff sets subscriber information “UE1” of mobile handset 100 under consideration and further, in this example, sets the paging flag to be valid. As for mobile handsets 100 carrying out mobile handset tracking processing, the system may be devised so that a plurality, rather than one, can be registered. In the case of tracking a plurality of mobile handsets having different subscriber information, the maintenance staff inputs the subscriber information of this plurality of mobile handsets from the settings screen of the OAM device. If a situation with tracking of a plurality of mobile handsets is administered with states such as tracking in progress, tracking lost, tracking completed and tracking reserved, maintenance staff 107 is able to administer the tracking situation of a plurality of mobile handsets with one screen.

OAM device 105 sets, in mobile handset tracking processing condition database 512, the information set by maintenance staff 107.

FIGS. 13A and 13B are diagrams describing a mobile handset tracking condition database and a wireless communication system class database of an OAM device.

FIG. 13A is a diagram showing mobile handset tracking processing condition database 512 of OAM device 105. Since maintenance staff 107 has input “UE1” as the subscriber information of mobile handset 100 and input the paging flag to be valid, the subscriber information of the mobile handset desired to be tracked is set to “UE1” and the paging flag is set to be valid, in mobile handset tracking processing condition database 512.

FIG. 13B is a diagram showing wireless communication system class database 514 of OAM device 105. Since maintenance staff 107 has made an input so as to track wireless communication system 1, wireless communication system 1 is set as the object of tracking in wireless communication system class database 514. If mobile handset tracking processing conditions are set, OAM device 105 transmits a visited cell acquisition request enquiring about visited cell information of mobile handset 100 under consideration to call processing control device 102 (Step 616). In this visited cell information acquisition request, a subscriber information item (“UE1”) of the mobile handset subject to tracking and a paging flag information item (“Valid”) are included.

If call processing control device 102 receives a visited cell 106 information acquisition request for mobile handset 100 from OAM device 105, it checks the state of mobile handset 100 under consideration on the basis of information included in the acquisition request (Step 617). In this example, call processing control device 102 judges that mobile handset 100 is in the Idle state, since mobile handset 100 under consideration made a transition to the Idle state with the Idle transition of Step 610.

In the case where the paging flag is set to be valid in the visited cell information acquisition request of Step 616 and it is judged that the state of mobile handset 100 is the Idle state, call processing control device 102 transmits a paging message with respect to the cells of the paging area of mobile handset 100 (Step 618). Specifically, since “Cell 1”, “Cell 2”, and “Cell 3” are set in paging area information database 412, call processing control device 102 judges, from base station information database 312, that base stations 101 administering “Cell 1”, “Cell 2”, and “Cell 3” are, respectively, base station A 101-1, base station B 101-2, and base station C 101-3, and transmits a paging message to base station A 101-1, base station B 101-2, and base station C 101-3. Base station A 101-1, base station B 101-2, and base station C 101-3 transmit the paging message received from call processing control device 102 to mobile handset 100.

Since mobile handset 100 has received a paging message from cell a 106-1 of base station A 101-1, it transmits, via cell a 106-1 of base station A 101-6, a paging message reply message to call processing control device 102 (Step 619). Base station A 101-1, having received the paging message reply message, includes cell a 106-1 as visited cell information of mobile handset 100 in the visited cell information report message and transmits the same to call processing control device 102.

Mobile handset 100 and call processing control device 102 after the paging processing make a transition to the Active state in which data communication is possible (Step 620 and Step 621). Call processing control device 102 receives, from base station A 101-1, a paging message reply message in which cell a 106-1 is included as mobile handset 100 visited cell information. Call processing control device 102 reports the mobile handset 100 visited cell information received from base station A 101-1 to OAM device 105 (Step 622).

FIG. 14 is a diagram showing a mobile handset location information database of an OAM device.

In FIG. 14, OAM device 105 assumes that cell a 106-1 of base station A 101-1 has been reported from call processing control device 102 as mobile handset 100 visited cell information. The OAM device sets “Cell 1”, which is the cell identifier of cell a 106-1 of base station A 101-1, in mobile handset location information database 513.

OAM device 105 displays, on the basis of the visited cell information received from call processing control device 102, the fact that the cell in which mobile handset 100 subject to tracking is present is cell a 106-1 on the screen (Step 623). Maintenance staff 107 judges that mobile handset 100 is currently present in cell a 106-1.

In the present embodiment, an explanation was given using a cell identifier as location information for the mobile handset 100 desired to be tracked by maintenance staff 107, but even if the identifier is a base station identifier indicating base station 101 or an area identifier of an area to which base station 101 is attached, rather than a cell identifier, similar processing is possible.

In the present embodiment, visited cell information about mobile handset 100 in the Idle state was acquired by transmitting a paging message from call processing control device 102 at the initiative of OAM device 105, but even with an emergency paging message, rather than a paging message, similar processing is possible. As for emergency paging messages, it is possible to carry out mobile handset tracking processing with greater certainty, since an emergency paging message and a reply message to an urgency paging message are transmitted and received with priority, even if base station 102 is in a congested state and even going as far as disconnecting another call.

As for the present embodiment, there was shown an example in which visited cell information with which a reply message is transmitted by mobile handset 100 after reception of a paging message is reported to OAM device 105, but, taking the opportunity of receiving the paging message, or returning a paging message reply message, it is also possible to devise the system so that mobile handset 100 activates a function of acquiring location information that is more detailed than visited cell information. As a function of acquiring more detailed location information, there is e.g. a positioning function which, using the power attenuation or delay time of a control signal received by mobile handset 100 from base station 101 and measuring the distance between three or more base stations and the concerned mobile handset 100, is capable of specifying the location information of mobile handset 100. After acquiring location information that is more detailed than mobile handset 100 visited cell information by means of a positioning function, call processing control device 102 reports the location information that is more detailed than visited cell information to OAM device 105.

Also, in the present embodiment, there was shown an example in which the cell which has progressively transmitted the reply message of the mobile handset 100 that has received a paging message is reported to OAM device 105 as visited cell information, but, taking the opportunity of receiving the paging message, or returning a paging message reply message, mobile handset 100 may also activate a function of reporting the visited cell information at regular intervals to call processing control device 102. Call processing control device 102 transmits visited cell information at regular intervals to OAM device 105, if visited cell information is acquired from mobile handset 100 by means of this function.

In addition, the present embodiment is one in which an indication was given regarding a method of tracking a mobile handset 100 supporting one wireless communication system 108, but in the case where the wireless communication system that is the object of tracking a mobile handset is single, the wireless communication system class database of the OAM device can be omitted. Even if what is concerned is a mobile handset 100 supporting two or more wireless communication systems 108 (“dual terminal”), similar processing is possible, and in the case of tracking a mobile handset 100 having a dual terminal function, it is acceptable, in the settings of the mobile handset tracking processing conditions in OAM device 105, to designate plurally, or in a one-by-one order, the wireless communication systems for which mobile handset tracking processing is desired.

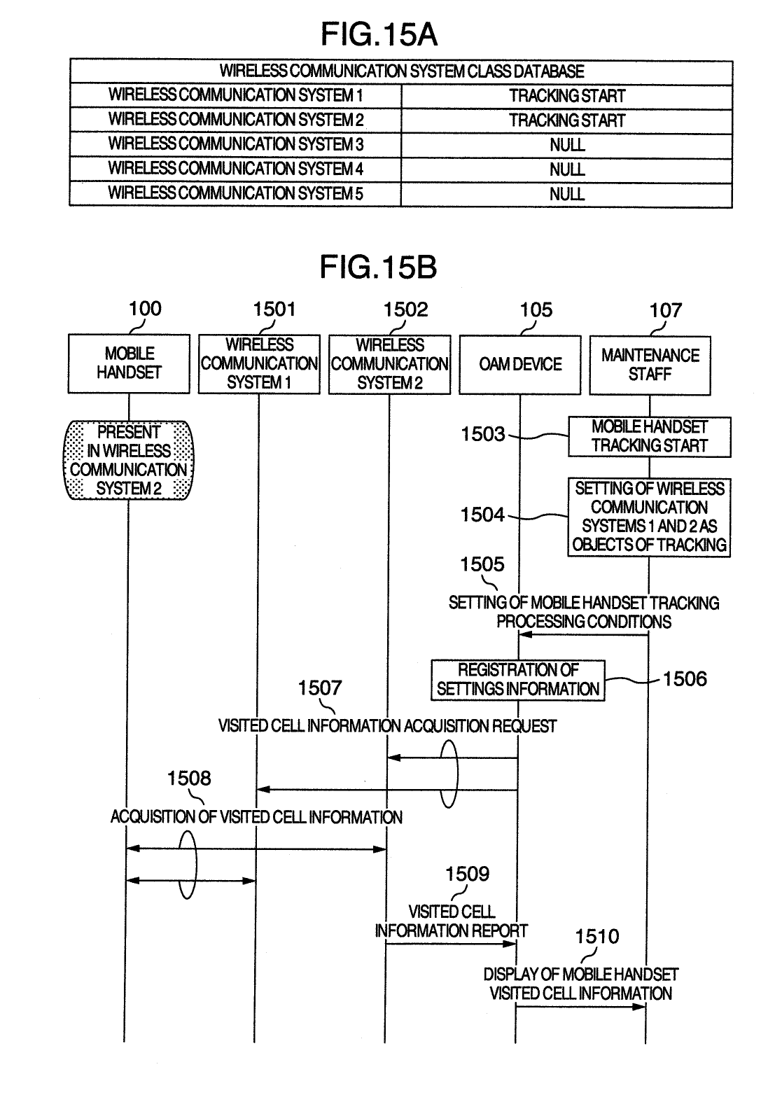

FIGS. 15A and 15B are diagrams showing a wireless communication system class database of an OAM device and a sequence in the case of carrying out mobile handset tracking processing in a plurality of wireless communication systems.

FIG. 15A is a diagram showing wireless communication system class database 514 of OAM device 105. As wireless communication systems 108 for which it is desired to carry out mobile handset tracking processing, maintenance staff 107 sets wireless communication system 1 1501 and wireless communication system 2 1502 in OAM device 105. Wireless communication system 1 1501 and wireless communication system 2 1502 have the same configuration as that of wireless communication system 108 in FIG. 1.

FIG. 15B is a diagram showing a process sequence in the case where OAM device 105 carries out mobile handset tracking processing with respect to wireless communication system 1 1501 and wireless communication system 2 1502. Maintenance staff 107 and OAM device 105 carry out mobile handset tracking processing with the same method as that of Steps 613 to 617 in FIG. 6 (Step 1503, Step 1504, Step 1505, and Step 1506). OAM device 105 transmits a visited cell information acquisition request to wireless communication system 1 1501 and wireless communication system 2 1502 (Step 1507). Mobile handset 100, wireless communication system 1 1501, and wireless communication system 2 1502 carry out, in case mobile handset 100 is in the Idle state, acquisition of visited cell information with the same method as that of Steps 618 and 619 in FIG. 6 (Step 1508).

Wireless communication system 2 1502, since it has detected that mobile handset 100 is under its own control, reports the visited cell information to OAM device 105 from call processing control device 102 attached to wireless communication system 2 1502 (Step 1509). OAM device 105 displays the visited cell information received from call processing control device 102 attached to wireless communication system 2 1502 on the screen (Step 1510). As for the present embodiment, there was shown a method in which a mobile handset 100 supporting one wireless communication system 108, but even if what is involved is a mobile handset 100 supporting two or more wireless communication systems 108 (dual terminal), the same processing is possible. In the case of tracking a mobile handset 100 having a dual terminal function and in the case of getting a grasp of a plurality of wireless communication systems 108 in which mobile handsets 100 are supported by a call processing control device 102, call processing control device 102, having received a mobile handset 100 visited cell information acquisition request, may transfer the visited cell information acquisition request received from OAM device 105 to other call processing control devices 102 attached on the side of wireless communication systems 108 that it does not itself support.

As yet another embodiment, it may also be considered that the OAM device of a certain wireless communication system detects that the mobile handset under consideration is under the administration of another wireless communication system and transmits a visited cell information acquisition request to the other wireless communication system.

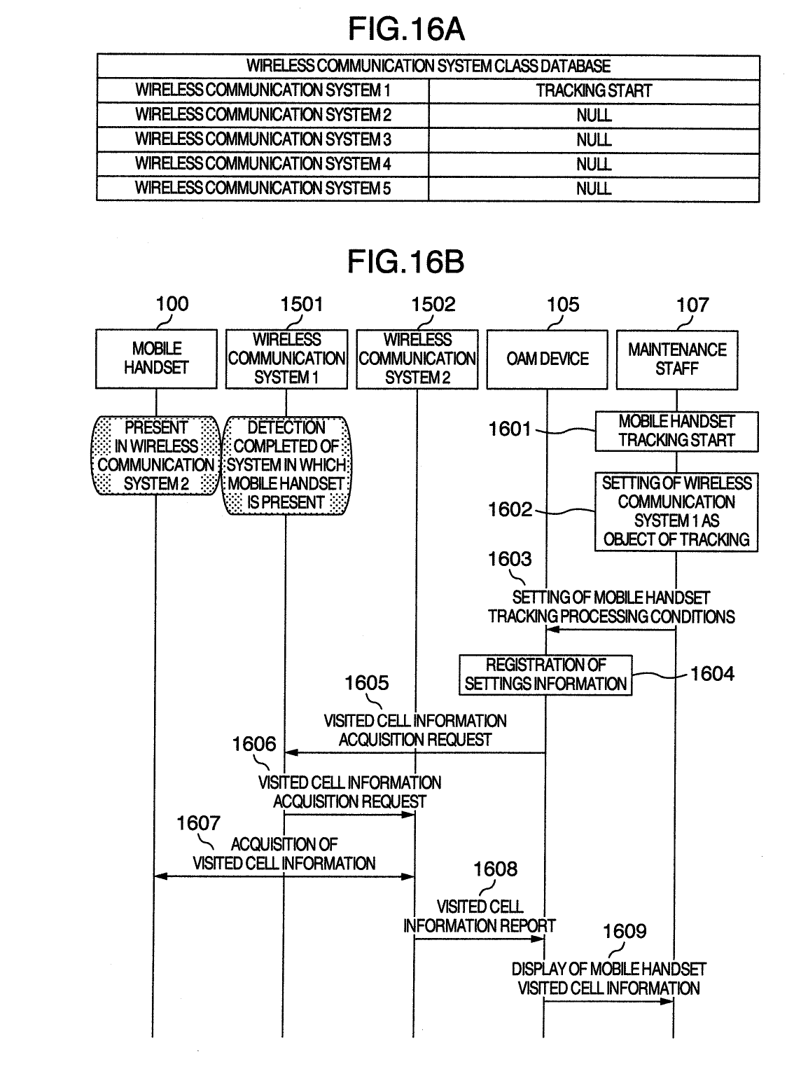

FIGS. 16A and 16B are diagrams showing a wireless communication system class database of an OAM device associated with an embodiment carrying out mobile handset tracking processing with respect to a plurality of wireless communication systems by means of cooperation between call processing control devices attached to a plurality of wireless communication systems, and the sequence in the case of carrying out mobile handset tracking processing.

FIG. 16A is a diagram showing a wireless communication system class database 514 of an OAM device 105. Maintenance staff 107 sets wireless communication system 1 1501 in OAM device 105 as the wireless communication system 108 in which it desires to carry out mobile handset tracking processing.

FIG. 16B is a diagram showing the situation in which OAM device 105 carries out mobile handset tracking processing with respect to wireless communication system 1 1501.

Maintenance staff 107 and OAM device 105 carry out mobile handset tracking processing with the same method as that of Steps 613 to 617 in FIG. 6 (Step 1601, Step 1602, Step 1603, and Step 1604). OAM device 105 transmits a visited cell information acquisition request to wireless communication system 1 1501 (Step 1605). Since wireless communication system 1 1501 knows that mobile handset 100 is present in wireless communication system 2 1502, the visited cell information acquisition request is transferred from call processing control device 102 attached to wireless communication system 1 1501 to call processing control device 102 attached to wireless communication system 2 1502 (Step 1606).

In the case where mobile handset 100 is in the Idle state, mobile handset 100 and wireless communication system 2 1502 carry out acquisition of visited cell information with the same method as that used in Steps 618 and 619 in FIG. 6 (Step 1607). Since wireless communication system 2 1502 has detected that mobile handset 100 is under its own control, visited cell information is reported from call processing control device 102 attached to wireless communication system 2 1502 to OAM device 105 (Step 1608). OAM device 105 displays the visited cell information received from call processing control device 102 attached to wireless communication system 2 1502 on the screen (Step 1609).

In the plurality of the present embodiments explained above, it is possible to immediately get a grasp of the visited cell information of a mobile handset if the mobile handset subject to tracking is in the Idle state. Also, the transmission of a paging message and the reply message thereto are utilized for mobile handset tracking processing. Consequently, since voice calls or data calls are not transmitted to the mobile handset and no voice calls or data calls arrive, there is no generation of a ring tone or a vibrating action. Since it is possible to acquire visited cell information together with bringing a mobile handset subject to tracking into the Active state without generating a ring tone or a vibrating action, it is possible for the maintenance staff to get a grasp of the visited cell information of the mobile handset without being notices by the user of the mobile handset.

It should be further understood by those skilled in the art that although the foregoing description has been made on embodiments of the invention, the invention is not limited thereto and various changes and modifications may be made without departing from the spirit of the invention and the scope of the appended claims.

1. A wireless communication system having:
a plurality of base stations carrying out communication with mobile handsets by means of wireless communication lines; a call connection control device connected with said plurality of base stations and carrying out control of communication line connections with respect to said mobile handsets; a gateway device connected with said plurality of base stations and a call processing control device and connecting the communication lines of said mobile handsets with an Internet network; and a maintenance and administration device connected with said plurality of base stations and said call processing control device and gateway device and carrying out maintenance and operations administration of the entire system; in which:
said call processing control device administers the location information of said mobile handsets in units of paging areas including a plurality of cells covered by said base stations and, in the case where there is an incoming call to a mobile handset, carries out paging with respect to each cell of said paging area, and receives the paging reply and carries out settings administration of the communication lines; wherein,
if said maintenance and administration device transmits a mobile handset location acquisition request including mobile handset information and a paging flag,
said call processing control device transmits, on the basis of said mobile handset information and paging flag, a paging message irrespective of whether or not there is an incoming call with respect to mobile handsets in a standby state in the case where the paging flag is valid and, if receiving a paging reply from a mobile handset, reports the cell that progressively transmitted said paging reply to said OAM device.

2. A communication system including: a plurality of wireless communication systems having a plurality of base stations carrying out communication with mobile handsets by means of wireless communication lines; a call connection control device connected with said plurality of base stations and carrying out control of communication line connections with respect to said mobile handsets; a gateway device connected with said plurality of base stations and a call processing control device and connecting the communication lines of said mobile handsets with an Internet network; and having a maintenance and administration device carrying out maintenance and operations administration of each device of said plurality of wireless communication systems; wherein:
said respective call processing control devices of said plurality of wireless communication systems are devices that administer the location information of said mobile handsets in units of paging areas including a plurality of cells covered by said base stations and, in the case where there is an incoming call to a mobile handset, carry out paging with respect to each cell of said paging area, receive a paging reply, and carry out settings administration of the communication lines; and,
if said maintenance and administration device transmits a mobile handset location acquisition request including mobile handset information and a paging flag with respect to call processing control devices of one or more wireless communication systems in accordance with the information set by the maintenance administrator,
the respective call processing control devices of said one or more wireless communication systems transmit, on the basis said mobile handset information and paging flag, a paging message irrespective of whether there is an incoming call or not with respect to mobile handsets in a standby state in the case where the paging flag is valid and, if receiving a paging reply from a mobile handset, reports the cell that progressively transmitted said paging reply to said OAM device.

3. The communication system according to claim 2, wherein,
if the call processing control device of the first wireless communication system of said plurality of wireless communication systems judges that the mobile handset subject to location acquisition is under the administration of a second wireless communication system that differs from said first wireless communication system, the call processing control device of said first wireless communication system transfers the location acquisition request received from said maintenance and administration device to the call processing control device of said second wireless communication system.

4. A mobile handset location information acquisition method associated with a wireless communication system having: a plurality of base stations carrying out communication with mobile handsets by means of wireless communication lines; a call connection control device connected with said plurality of base stations and carrying out control of communication line connections with respect to said mobile handsets; a gateway device connected with said plurality of base stations and a call processing control device and connecting the communication lines of said mobile handsets with an Internet network; and a maintenance and administration device connected with said plurality of base stations and said call processing control device and gateway device and carrying out maintenance and operations administration of the entire system; wherein:
said call processing control device is a device that administers the location information of said mobile handsets in units of paging areas including a plurality of cells covered by said base stations and, in the case where there is an incoming call to a mobile handset, carry out paging with respect to each cell of said paging area, receive a paging reply, and carry out settings administration of the communication lines; and,
if said maintenance and administration device transmits a mobile handset location acquisition request including mobile handset information and a paging flag,
said call processing control device transmits, on the basis of said mobile handset information and paging flag, a paging message irrespective of whether or not there is an incoming call with respect to mobile handsets in a standby state in the case where the paging flag is valid and, if receiving a paging reply from a mobile handset, reports the cell that progressively transmitted said paging reply to said OAM device.

5. A mobile handset location information acquisition method associated with a communication system including: a plurality of wireless communication systems having a plurality of base stations carrying out communication with mobile handsets by means of wireless communication lines; a call connection control device connected with said plurality of base stations and carrying out control of communication line connections with respect to said mobile handsets; a gateway device connected with said plurality of base stations and a call processing control device and connecting the communication lines of said mobile handsets with an Internet network; and having a maintenance and administration device carrying out maintenance and operations administration of each device of said plurality of wireless communication systems; wherein:
said respective call processing control devices of said plurality of wireless communication systems are devices that administer the location information of said mobile handsets in units of paging areas including a plurality of cells covered by said base stations and, in the case where there is an incoming call to a mobile handset, carry out paging with respect to each cell of said paging area, receive a paging reply, and carry out settings administration of the communication lines; and,
if said maintenance and administration device transmits a mobile handset location acquisition request including mobile handset information and a paging flag with respect to call processing control devices of one or more wireless communication systems in accordance with the information set by the maintenance administrator,
the respective call processing control devices of said one or more wireless communication systems transmit, on the basis said mobile handset information and paging flag, a paging message irrespective of whether there is an incoming call or not with respect to mobile handsets in a standby state in the case where the paging flag is valid and, if receiving a paging reply from a mobile handset, reports the cell that progressively transmitted said paging reply to said OAM device.

6. The location information acquisition method according to claim 5, wherein,
if the call processing control device of the first wireless communication system of said plurality of wireless communication systems judges that the mobile handset subject to location acquisition is under the administration of a second wireless communication system that differs from said first wireless communication system, the call processing control device of said first wireless communication system transfers the location acquisition request received from said maintenance and administration device to the call processing control device of said second wireless communication system.
